(19) United States
(12) Patent Application Publication
(10) Pub. No.: US 2006/0020435 A1
(43) Pub. Date: Jan. 26, 2006

(54) Method of predicting noise of air conditioner, and method of manufacturing air conditioner using the same

(75) Inventors: Yong Hwa Choi, Suwon-si (KR); Hayase Gaku, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/150,257

(22) Filed: Jun. 13, 2005

(30) Foreign Application Priority Data
Jul. 1, 2004 (KR) 2004-51099

(51) Int. Cl. G06G 7/48

(52) U.S. Cl. 703/6

(57) ABSTRACT

A method of predicting a noise of an air conditioner, including modeling an operating condition, e.g., a shape of a heat exchanger or of a fan, a rotational speed of the fan, etc., obtaining information of a velocity of air by analyzing an air flow according to the modeled operating condition, and predicting a noise by analyzing the information of the velocity of air. A method of manufacturing an air conditioner, including modeling an operating condition, e.g., a shape of a heat exchanger or of a fan, a rotational speed of the fan, etc., predicting a noise by analyzing a velocity distribution of air at the rear of the heat exchanger in a modeled air conditioner, and determining whether a predicted noise is above a predetermined level, followed by remodeling the operating condition when the predicted noise is above the predetermined level, otherwise by manufacturing the air conditioner.

### CROSS-REFERENCE TO RELATED APPLICATION

This application claims the benefit of Korean Patent Application No. 2004-51099, filed on Jul. 1, 2004 in the Korean Intellectual Property Office, the disclosure of which is incorporated herein by reference.

### BACKGROUND OF THE INVENTION

1. Field of the Invention

The present invention relates to a method of predicting a noise of an air conditioner, and a method of manufacturing an air conditioner using the same, and, more particularly, to a method of predicting a noise caused by currents of air generated at the rear of a heat exchanger in an indoor unit of an air conditioner, and a method of designing the heat exchanger using the same.

2. Description of the Related Art

An air conditioner is an apparatus for cooling or heating a room with a cooling cycle comprising a compressor, a condenser, an expansion valve, an evaporator, and the like, and can be classified into an integral type air conditioner in which all components for the cooling cycle are equipped in one unit, and a separated type air conditioner in which indoor components and outdoor components are equipped in different units, respectively.

Among the separated type air conditioners, a wall-mounted air conditioner has a small sized indoor unit adapted such that the indoor unit can be mounted on a wall of the room. As shown in FIG. 1, the indoor unit of the wall-mounted air conditioner comprises a housing 10 formed with an intake vent 10a for intaking air and a discharge vent 10b for discharging air; a heat exchanger 11 equipped in the housing 10; and a cross flow fan 12 provided at the rear of the heat exchanger 11 for generating a flow force of air.

The heat exchanger 11 has a plurality of fins 11a positioned in parallel to each other, and a refrigerant pipe 11b equipped in the heat exchanger 11 such that the refrigerant pipe 11b penetrates the fins 11a. Each of the fins 11a is formed with a plurality of holes through which the refrigerant pipe 11b can penetrate the fins 11a. In order to increase heat transfer efficiency of the heat exchanger, a plurality of slits 11c are formed between the holes. While air taken into the housing passes through space between the respective fins 11a of the heat exchanger 11, the air absorbs heat transferred from a refrigerant flowing in the refrigerant pipe 11b or supplies the heat to the refrigerant flowing in the refrigerant pipe 11b.

Air, having passed through the heat exchanger 11, is discharged again into the room through the cross flow fan 12. Meanwhile, since air, having passed through the heat exchanger 11, bypasses the refrigerant pipe 11b or the slits 11c provided on the heat exchanger 11, it flows not at a constant velocity over an entire length of the heat exchanger in the lengthwise direction thereof, but at different velocities according to positions on the heat exchanger 11. Such a non-uniform flow of air enters the cross flow fan 12, causing a noise.

In order to reduce the noise, as is disclosed in Japanese Patent Laid-open No. 2000-292086, a fin having a saw tooth shape can be provided at downstream portion of an air flow, restricting occurrence of vortex flow, or as is disclosed in Japanese Patent Laid-open Publication No. (Hei) 06-034154, each of the fins may be formed with protrusions at a flat portion thereof, generating a uniform velocity of air discharged from the heat exchanger.

However, although the conventional techniques mentioned above present a method for changing distribution of the velocity of air at the rear of the heat exchanger, they do not actually address the relationship between a velocity distribution of air and occurrence of the noise. As a result, there is a problem in that the occurrence and degree of the noise cannot be predicted before an experiment is actually conducted on the manufactured air conditioner.

### SUMMARY OF THE INVENTION

The present invention has been made in view of the problems involved with the prior art, and one aspect of the present invention is to provide a method of predicting a noise generated in an air conditioner before manufacturing the air conditioner in practice.

It is another aspect of the present invention to provide a method of manufacturing an air conditioner using the method of predicting the noise of the air conditioner, thereby reducing costs and time for manufacturing a heat exchanger.

Additional aspects and/or advantages of the invention will be set forth in part in the description which follows and, in part, will be obvious from the description, or may be learned by practice of the invention.

In one exemplary embodiment, the present invention provides a method of predicting a noise of an air conditioner, comprising modeling an operating condition of the air conditioner, including one or more of a shape of a heat exchanger, a shape of a fan, and a rotational speed of the fan, obtaining information of a velocity of air by analyzing an air flow according to the modeled operating condition; and c) predicting a noise by analyzing the information of the velocity of air.

Predicting a noise by analyzing the information of the velocity may comprise transforming the information of the velocity of air to information of a velocity of air in a time domain, and transforming the information of a velocity of air in the time domain to information of a velocity of air in a frequency domain.

The information of a velocity of air obtained by analyzing the air flow according to the modeled operating condition may be presented as information of the velocity of air at respective positions spaced a predetermined distance from a rear end of a fin on the heat exchanger.

The information of the velocity of air at the respective positions may be transformed to information of the velocity of air in the time domain by transforming the information of the velocity of air at the respective positions to information of a velocity of air at respective times when air collides with a fan blade, using a velocity of the fan blade.

After obtaining a velocity profile represented by a system of coordinates having an axis of respective positions for the velocity of air, and another axis of the velocity of air, the information of the velocity of air in the time domain may be obtained by dividing values of the axis representing the respective positions by a linear velocity of the fan blade.

A spectrum of velocity may be given by applying a Fourier Transformation to the information of the velocity of air in the time domain.

Predicting the noise by analyzing the information of the velocity of air may further comprise predicting a noise level from values of first to third peaks in the spectrum.

In a second exemplary embodiment, the present invention provides a method of manufacturing an air conditioner, comprising modeling an operating condition of the air conditioner, including one or more of a shape of a heat exchanger, a shape of a fan, a rotational speed of the fan, predicting a noise by analyzing a velocity distribution of air at the rear of the heat exchanger in a modeled air conditioner; and determining whether a predicted noise is above a predetermined level or not, followed by remodeling the operating condition when the predicted noise is above the predetermined level, otherwise by manufacturing the air conditioner according to the modeled operating condition when the predicted noise is not above the predetermined level.

In a third exemplary embodiment, the present invention provides a method of manufacturing an air conditioner, comprising repeating one or more times processes of modeling an operating condition, including a shape of a heat exchanger, a shape of a fan, a rotational speed of the fan, and the like, followed by predicting a noise level from a velocity distribution of air at the rear of a heat exchanger manufactured according to the operating condition, and manufacturing the air conditioner according to a model predicted to have a lowest noise level among results obtained by repeating the processes of modeling and predicting.

The process of predicting the noise level from the velocity distribution of air comprises obtaining a velocity spectrum after transforming the velocity distribution of air to information of a velocity of air in a frequency domain, and predicting the noise level from values of first to third peaks of the velocity spectrum.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a sectional side elevation illustrating an indoor unit of a conventional air conditioner;

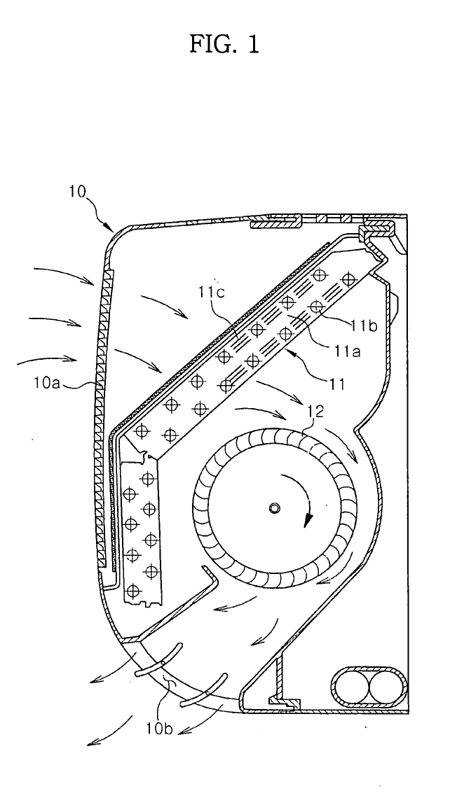

FIG. 2 is a flow diagram of a method of predicting a noise of an air conditioner consistent with a first exemplary embodiment of the present invention;

FIG. 3 is a view illustrating one example of a modeled heat exchanger and a modeled fan;

FIG. 4 is a view illustrating air currents at the rear of the modeled heat exchanger of FIG. 3;

FIG. 5 is a graphical representation depicting a velocity distribution for respective points spaced a predetermined distance D from the heat exchanger of FIG. 4;

FIG. 6 is a graphical representation depicting the velocity distribution to a time transformed from the velocity distribution shown in FIG. 5;

FIG. 7 is a graphical representation depicting a velocity spectrum given by Fourier Transformation of the velocity distribution of FIG. 6;

FIG. 8 is a graphical representation depicting a noise measured in an air conditioner manufactured according to the model of FIG. 3;

FIG. 9 is a flow diagram of a method of manufacturing an air conditioner consistent with a second exemplary embodiment of the present invention;

FIG. 10 is a flow diagram of a method of manufacturing an air conditioner consistent with a third exemplary embodiment of the present invention;

FIG. 11A is a front view illustrating the shape of fins of a conventional heat exchanger;

FIG. 11B is a plan view illustrating the shape of fins of another conventional heat exchanger;

FIG. 12A is a front view illustrating the shape of fins of an enhanced heat exchanger;

FIG. 12B is a plan view illustrating the shape of fins of another enhanced heat exchanger;

FIG. 13 is a graphical representation depicting the velocity distribution of air at the rear of the conventional heat exchanger and the enhanced heat exchanger;

FIG. 14 is a graphical representation depicting a first peak and a second peak of a spectrum given by applying the Fourier Transformation to the information of the velocity in a time domain after transforming the graphical representation of FIG. 13 to the information of the velocity in the time domain;

FIG. 15 is a graphical representation depicting a noise measured in an air conditioner manufactured according to the shape of the conventional heat exchanger; and

FIG. 16 is a graphical representation depicting a noise measured in an air conditioner manufactured according to the shape of the enhanced heat exchanger.

### DETAILED DESCRIPTION OF THE EXEMPLARY, NON-LIMITING EMBODIMENTS

Reference will now be made in detail to the embodiments of the present invention, examples of which are illustrated in the accompanying drawings, wherein like reference numerals refer to the like elements throughout. The exemplary embodiments are described below to explain the present invention by referring to the figures.

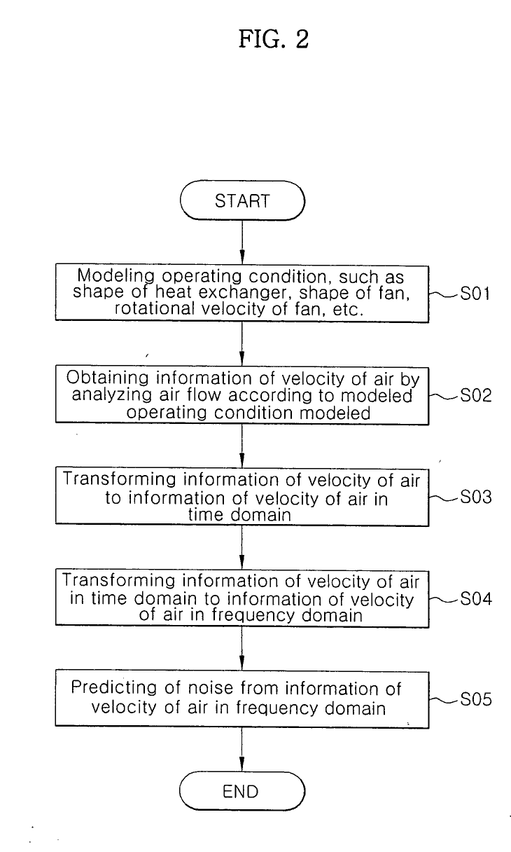

A method of predicting a noise of an air conditioner consistent with a first exemplary embodiment of the present invention predicts the noise based on a velocity distribution of air flowing at the rear of a heat exchanger and, as shown in FIG. 2, comprises the steps of: modeling an operating condition, such as a shape of a heat exchanger, a shape of a fan, a rotational velocity of the fan, and the like (Step S01); obtaining information of a velocity of air by analyzing an air flow according to the operating condition modeled in Step S01 (Step S02); and predicting a noise by analyzing the information of the velocity (Steps S03, S04 and S05).

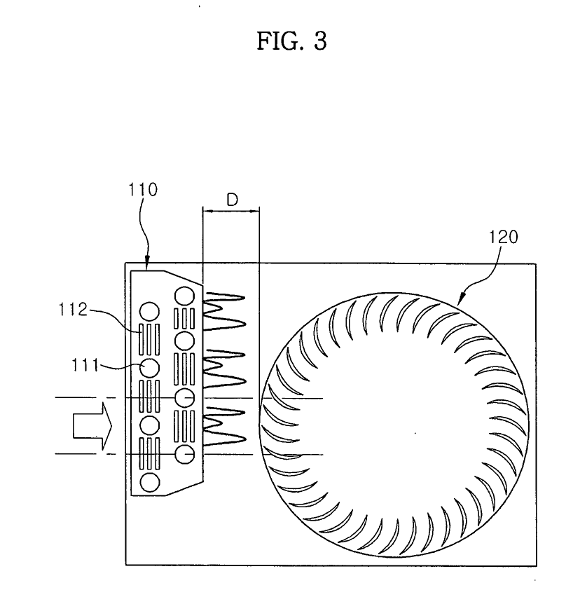

In Step S01, as shown in FIG. 3, the operating condition, such as a shape of fins 110 constituting a heat exchanger, a shape of a fan 120, a distance D between the heat exchanger and the fan 120, a shape of slits 112 provided between two adjacent sections of a refrigerant pipe 111 passing through the fins 110, and the like, are modeled. As is described below, among the operating conditions, the shape of the slits 112 is a particularly important factor for controlling the noise.

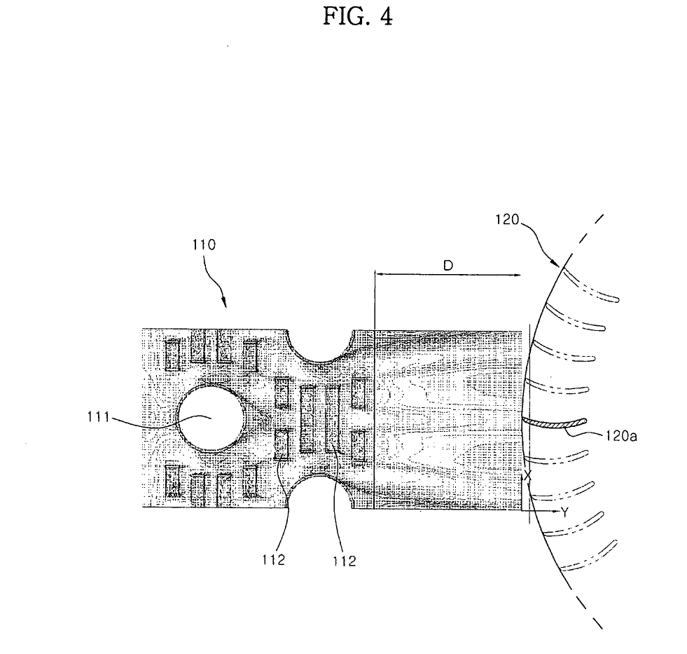

Thereafter, in the step of obtaining the information of the velocity (Step S02), a flow of air according to the operating condition determined in the step of modeling the operating condition is analyzed. That is, as the air conditioner starts to operate, rotating the fan 120 at a predetermined velocity, the flow of air surrounding the heat exchanger and the fan 120 reaches a steady state, and a velocity distribution of the steady state is computed. The computation for the velocity distribution of the steady state is carried out by a numerical analysis method using a program of Computational Fluid Dynamics (CDF). One example of air currents obtained through this computation is shown in FIG. 4, and is given by the operating condition modeled to have a fan 120, which has a diameter of 86 mm and a rotational velocity of 1,247 rpm, and which is spaced a distance of 15.5 mm from the heat exchanger. As is apparent from the computation for the velocity distribution shown in FIG. 4, it can be appreciated that the air currents flow at different velocities at every position at the rear of the heat exchanger, exhibiting different velocity distributions due to friction and interference with the refrigerant pipe 111 or the slits 112.

When such a flow of air having a non-uniform velocity distribution comes into the fan 120, a fan blade 120a collides with air, flowing at different velocities according to positions of the fan blade 120a (or according to a time), and it is predicted that such a collision of air with the fan blade 120 causes the noise in the air conditioner. Accordingly, the velocity distribution of air at respective points where the flow of air collides with the fan blade 120a is a major concern.

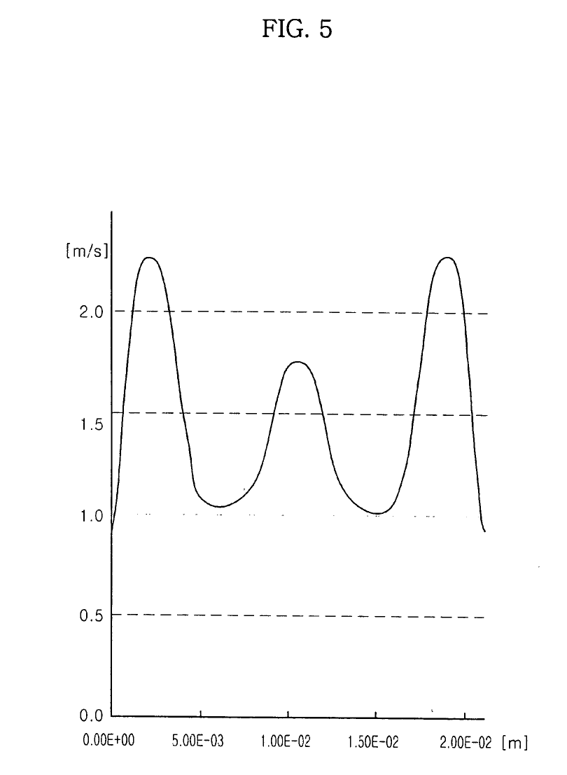

FIG. 5 is a graphical representation of the velocity distribution according to positions spaced a predetermined distance D from a rear end of the fin 110 to the heat exchanger in the air currents of FIG. 4, depicting the velocity distribution in the direction of the Y-axis for the respective points on the X-axis centered on a point spaced the predetermined distance D from the lower end of the fin 110. Since the flow of air has the velocity distribution not only in the direction of the Y-axis, but also in the direction of the X-axis and in the direction of the Z-axis, not shown, perpendicular to both the X-axis and the Y-axis of FIG. 4, the velocity distributions in the direction of the X-axis and in the direction of the Z-axis can also be the subject of analysis. However, since the flow of air in the direction of the Y-axis is the major direction of the flow of air in the present embodiment, it can be assumed that the flow of air in the direction of the Y-axis has the greatest influence on the noise, and thus, only the velocity distribution in the direction of the Y-axis is the subject of analysis in the present embodiment.

A velocity profile shown in FIG. 5 is the velocity distribution for the respective points on the X-axis of FIG. 4, that is, information of a velocity of air for the positions.

Next, in the step of predicting the velocity of air, the information of the velocity obtained in Step S02 is transformed into more useful information, and then, the noise is predicted.

As shown in FIG. 4, the fan blade 120a undergoes a circular motion along an arc of a circle shown by a dotted line while sequentially passing from the lower end of the flow of air to the upper end of the flow of air. Meanwhile, assuming that the fan blade 120a undergoes an approximately linear motion in a predetermined modeled section, its movement path is parallel to the X-axis, and at this time, the velocity distribution of air, colliding with the fan blade 120a at respective positions where the fan blade 120a passes by, is the same as the velocity distribution shown in FIG. 5. Accordingly, it can be said that FIG. 5 is the velocity distribution of air, colliding with the fan blade 120a according to the positions of the fan blade 120a when the fan blade 120a rotates.

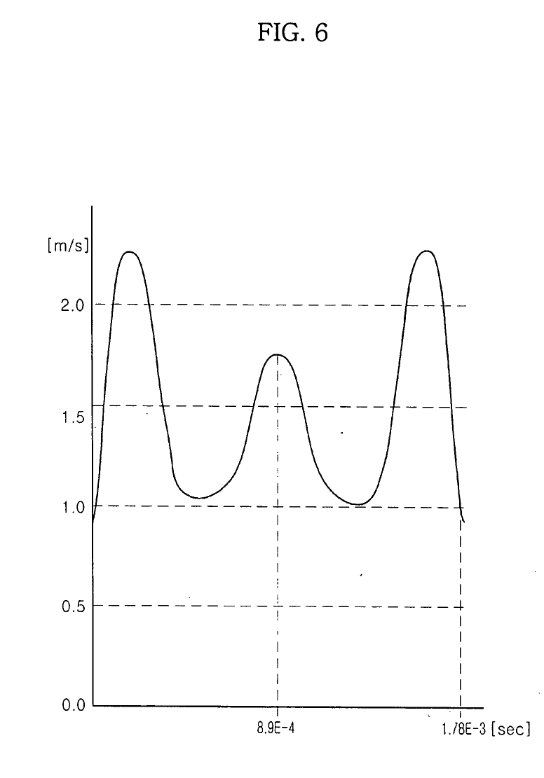

Meanwhile, since the fan blade 120a rotates at a predetermined velocity, information of a velocity of air for a time when air collides with the fan blade 120a can be obtained by dividing respective values on the horizontal axis of FIG. 5 with a linear velocity of the fan blade 120a. That is, the velocity distribution of air, colliding with the fan blade 120a according to lapse of time, can be obtained. The linear velocity of the fan blade 120a is a value obtained by multiplying an angular velocity of the fan blade 120a with a radius of the fan blade 120a, and in the above example, the linear velocity of the fan blade 120a is 11.23 m/s. A graph shown in FIG. 6 depicts the velocity distribution for the lapse of time, obtained by dividing the values of the horizontal axis of FIG. 5 with the linear velocity of the fan blade 120a. Compared with the velocity distribution shown in FIG. 5, although a velocity profile of FIG. 6 is the same shape as that of the velocity profile shown in FIG. 5, the information of the velocity of air for the positions is transformed into information of a velocity of air for the lapse of time. That is, FIG. 6 depicts the velocity distribution of air in a time domain.

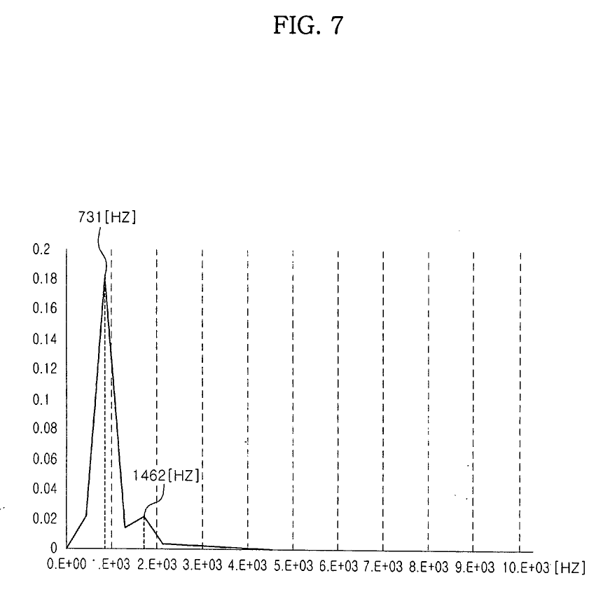

In order to observe the velocity distribution of FIG. 6 in a frequency domain, a spectrum as shown in FIG. 7 is given by applying the Fourier Transformation to the velocity profile of FIG. 6.

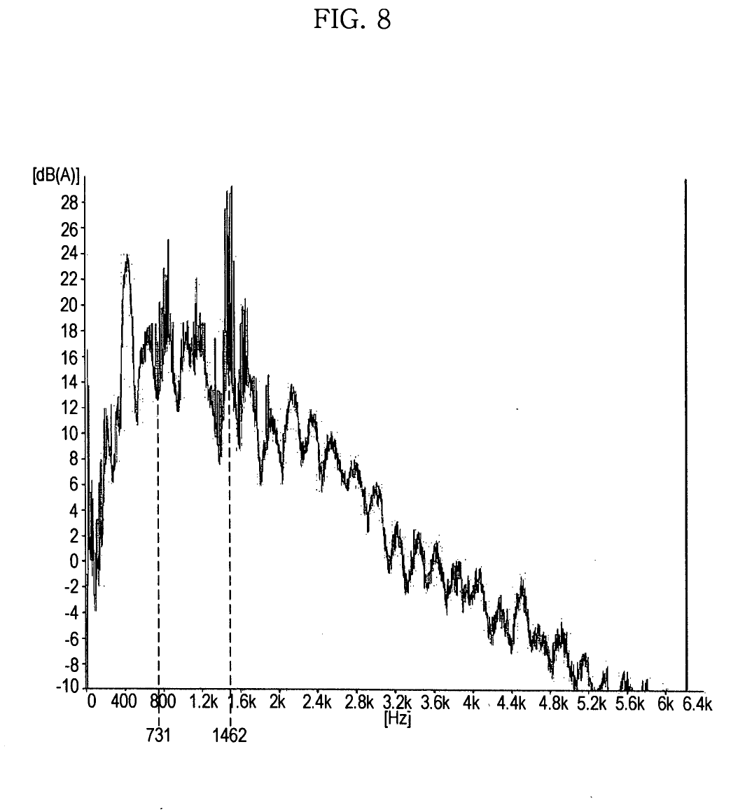

The applicant of the invention disclosed herein predicts that a value of the spectrum, particularly, values corresponding to first to third peaks of the spectrum are the factors associated with the noise, and a graph verifying the prediction of the applicant through an experiment is shown in FIG. 8. That is, FIG. 8 shows a noise level for respective frequencies, which is measured for an air conditioner practically manufactured under the operating condition presented in the step of modeling the operating condition. Compared with the spectrum shown in FIG. 7, it can be appreciated that the noise levels at a frequency of the first peak (that is, 731 Hz) and at a frequency of the second peak (that is, 1,462 Hz) are actually increased. Specifically, the noise level is remarkably high at the frequency of the second peak of the spectrum. Meanwhile, since the noise at the frequency of the first peak is masked by other noise in an indoor unit of the air conditioner, the noise at the frequency of the first peak is generally not a serious problem. According to results of the experiment, it can be seen that the values of the first to third peaks of the spectrum are in proportion to the real noise level.

As is described above, the noise level can be predicted using the values of the first through third peaks in the spectrum for the velocity, which is the information of the velocity of air in the frequency domain, obtained in such a way that, after presenting the information of the velocity, and transforming the information of the velocity of air for the lapse of time taken by the fan blade 120a, the information of the velocity of air in the frequency domain is given by applying the Fourier Transformation to the information of the velocity of air for the lapse of time.

A method of manufacturing an air conditioner consistent with a second exemplary embodiment of the present invention will be described as follows.

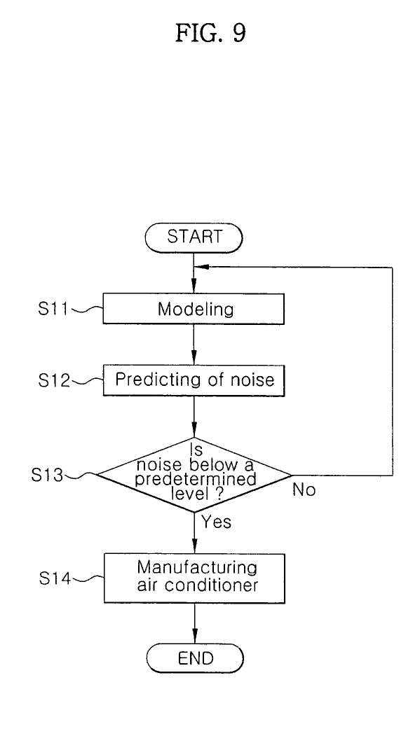

The method of manufacturing the air conditioner consistent with a second exemplary embodiment of the present invention relates to a method of manufacturing an air conditioner minimizing the noise using the method of predicting the noise of the air conditioner described above. As shown in FIG. 9, the method of manufacturing the air conditioner according to the this embodiment of the present invention comprises the steps of: modeling an operating condition, including a shape of a heat exchanger, a shape of a fan, a rotational speed of the fan, and the like; predicting a noise of a modeled air conditioner using the method of predicting the noise of the air conditioner described above; determining whether a predicted noise is below a predetermined level or not; and remodeling the operating condition when the predicted noise is above the predetermined level, or manufacturing the air conditioner according to modeled operating condition when the predicted noise is below the predetermined level.

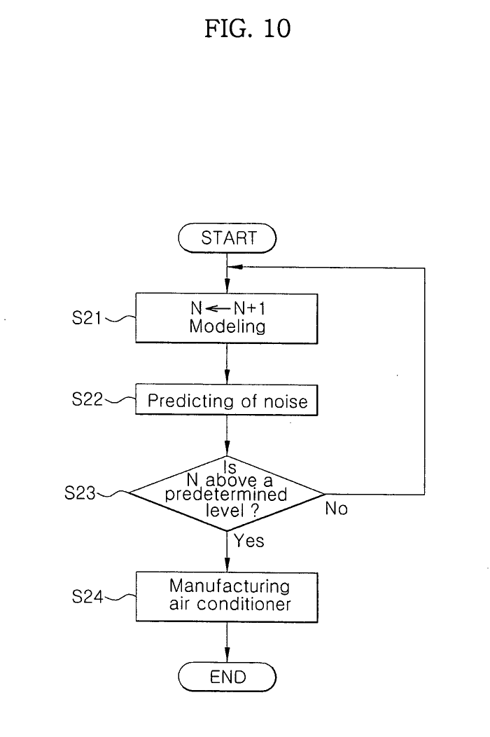

If standards for the predicted noise level are not determined, as shown in FIG. 10, modeling and predicting processes are repeated one or more times, and the air conditioner is manufactured according to a model predicted to have a lowest noise level among the results obtained by repeating the modeling and predicting processes.

The method of manufacturing the air conditioner will be described with reference to an actual design of the air conditioner.

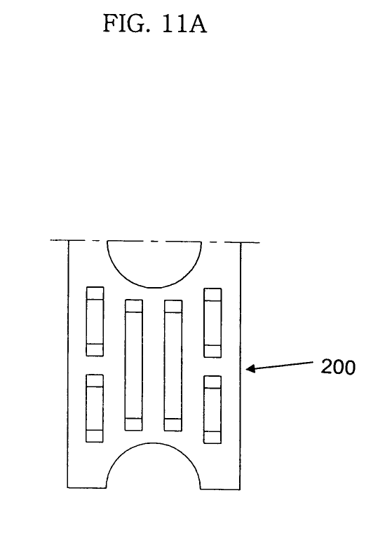

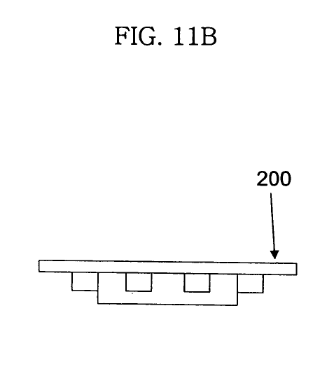

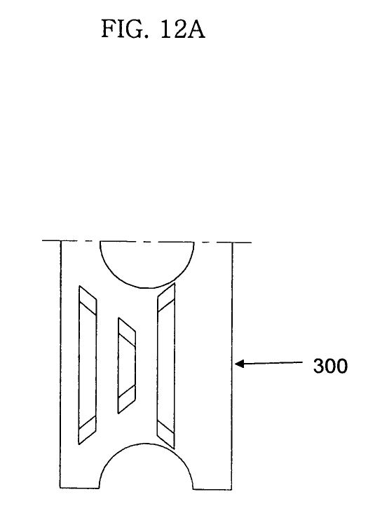

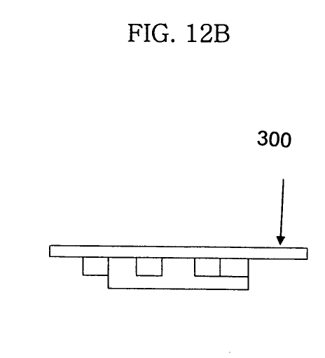

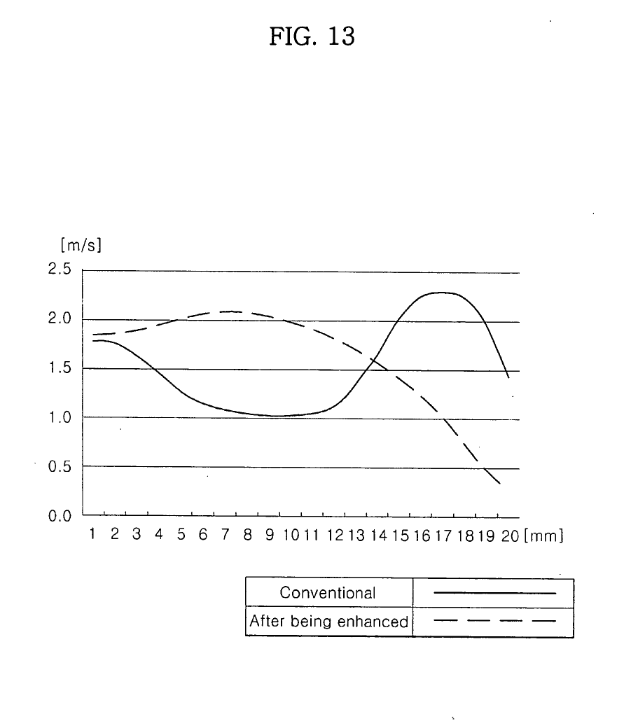

FIGS. 11A and 11B are front views illustrating the shape of a fin 200 of a conventional heat exchanger, and FIGS. 12A and 12B are front views illustrating the shape of a fin 300 of an enhanced heat exchanger. An air conditioner is modeled to have an operating condition in which a fan has a diameter of 86 mm and a rotational velocity of 1,247 rpm, and the fan is spaced a distance of 15.5 mm from the heat exchanger. A velocity distribution of air at the rear of the heat exchanger, obtained by the numerical analysis method, is shown in FIG. 13. A graph shown in FIG. 13 depicts the results of analysis for the velocity distribution of air flowing in a half of sections between the refrigerant pipes on the fin of the heat exchanger, in which the origin on the horizontal axis means the middle point between the refrigerant pipes. In the graph shown in FIG. 13, a velocity profile indicated by a dotted line exhibits the velocity distribution according to the shape of the conventional heat exchanger, while a velocity profile indicated by a solid line exhibits the velocity distribution according to the shape of the enhanced heat exchanger.

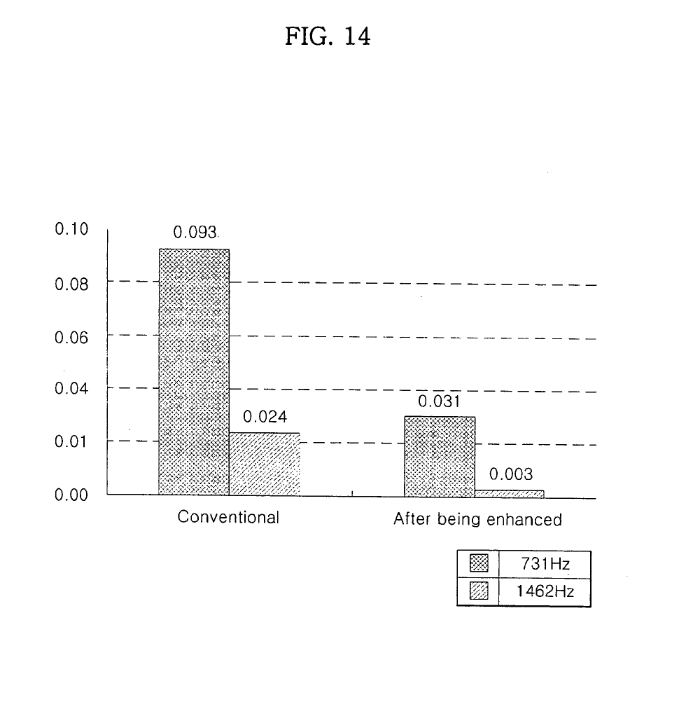

After transforming this velocity profile into information of a velocity of air in a time domain according to a velocity of the fan blade, and followed by applying the Fourier Transformation to the information of the velocity of air in the time domain, a value of a spectrum at first and second peaks can be obtained. FIG. 14 shows a value of the spectrum, in which in case of the conventional fins 200, the value of the spectrum at the first peak (731 Hz) is 0.093 and the value of the spectrum at the second peak (1,462 Hz) is 0.024, whereas in case of the revised fins 300, the value of the spectrum at the first peak (731 Hz) is 0.031 and the value of the spectrum at the second peak (1,462 Hz) is 0.003. Accordingly, it can be appreciated that the value of the spectrum at the first peak in case of the revised fins 300 is lowered to 1/3 of that in case of the conventional fins 200, and the value of the spectrum at the second peak in case of the revised fins 300 is lowered to 1/8 of that in case of the conventional fins 200. Accordingly, it is predicted that the air conditioner manufactured according to the shape of the revised fins 300 generates less noise than the air conditioner manufactured according to the shape of the conventional fins 200.

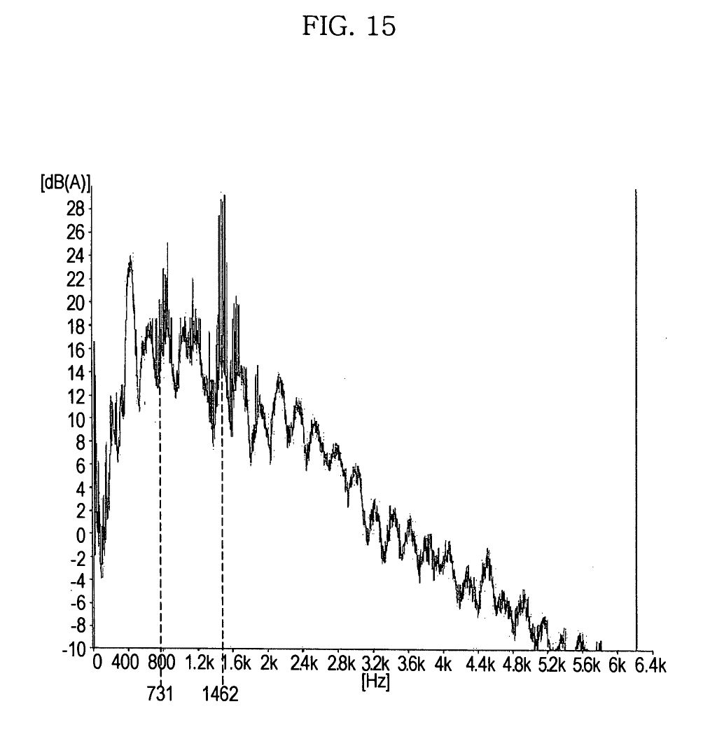

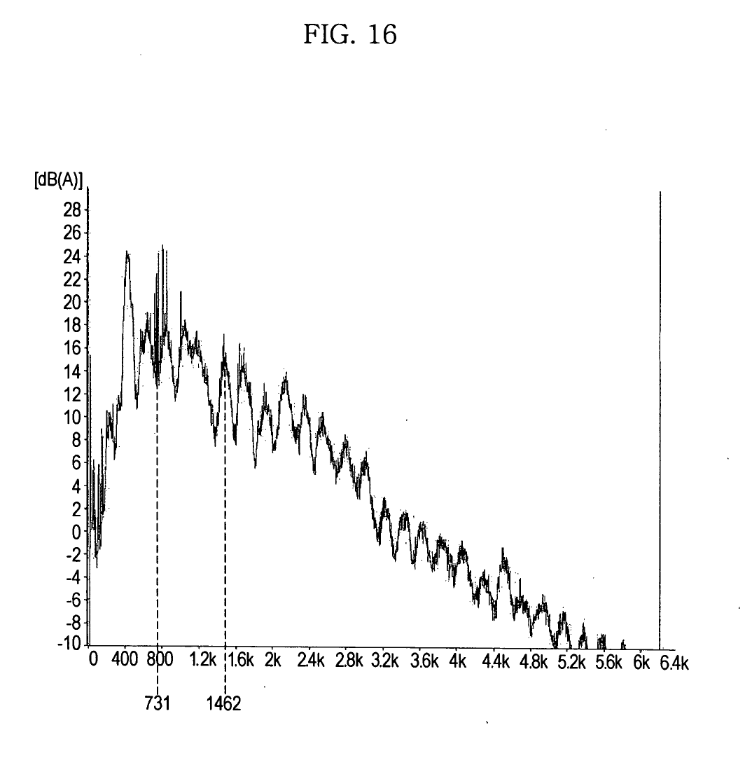

FIGS. 15 and 16 show noise levels measured in an air conditioner practically manufactured according to the modeled shape of the conventional heat exchanger. FIG. 15 is a graphical representation depicting the noise level measured in the air conditioner manufactured according to the shape of the conventional fins 200, and FIG. 16 is a graphical representation depicting the noise level measured in the air conditioner manufactured according to the shape of the revised fins 300. As shown in the FIGS. 15 and 16, it can be appreciated that, in the air conditioner having the revised fins 300, the noise level at the second peak is remarkably reduced. Meanwhile, the reduction in the noise level at the first peak is remarkable, and as described above, this is attributed to the fact that the noise at the first peak is masked by the other noises, and is thus not represented.

As described above, the occurrence of the noise in the air conditioner can be minimized by continuously changing the shape of the fins on the heat exchanger, particularly, the shape of the slits such that the value at the first and second peaks or the third peak of the spectrum are reduced.

As is apparent from the above description, according to the method of predicting the noise of the air conditioner, there are advantageous effects in that the occurrence of the noise can be predicted prior to practically manufacturing the product, and in that the air conditioner can be manufactured using the prediction for the occurrence of the noise, thereby reducing manufacturing costs and time.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of predicting a noise of an air conditioner, comprising:
modeling an operating condition of the air conditioner, including one or more of a shape of a heat exchanger, a shape of a fan, and a rotational speed of the fan;
obtaining information of a velocity of air by analyzing an air flow according to the modeled operating condition; and
predicting a noise by analyzing the information of the velocity of air.

2. The method according to claim 1, wherein predicting a noise by analyzing the information of the velocity of air comprises:
transforming the information of the velocity of air to information of a velocity of air in a time domain; and
transforming the information of the velocity of air in the time domain to information of a velocity of air in a frequency domain.

3. The method according to claim 2, wherein the information of the velocity of air obtained by analyzing an air flow according to the modeled operating condition is presented as information of a velocity of air at respective positions spaced a predetermined distance from a rear end of a fin on the heat exchanger.

4. The method according to claim 3, wherein the information of the velocity of air at the respective positions is transformed to the information of the velocity of air in the time domain by transforming the information of the velocity of air at the respective positions to information of a velocity of air colliding with a fan blade at respective times, using a velocity of the fan blade.

5. The method according to claim 4, further comprising:
obtaining a velocity profile represented by a system of coordinates having an axis of respective positions for the velocity of air, and another axis of the velocity of air; and
obtaining the information of the velocity of air in the time domain by dividing values of the axis of the respective positions with a linear velocity of the fan blade.

6. The method according to claim 5, wherein a velocity spectrum is given by applying a Fourier Transformation to the information of the velocity of air in the time domain.

7. The method according to claim 6, wherein predicting a noise by analyzing the information of the velocity of air further comprises predicting a noise level from values of first to third peaks of the velocity spectrum.

8. A method of manufacturing an air conditioner, comprising:
modeling an operating condition of the air conditioner, including one or more of a shape of a heat exchanger, a shape of a fan, and a rotational speed of the fan;
predicting a noise by analyzing a velocity distribution of air at the rear of the heat exchanger in a modeled air conditioner; and
determining whether a predicted noise is above a predetermined level or not, followed by remodeling the operating condition when the predicted noise is above the predetermined level, otherwise by manufacturing the air conditioner according to the modeled operating condition when the predicted noise is not above the predetermined level.

9. A method of manufacturing an air conditioner, comprising:
repeating one or more times processes of modeling an operating condition of the air conditioner, including one or more of a shape of a heat exchanger, a shape of a fan, and a rotational speed of the fan, followed by predicting a noise from a velocity distribution of air at the rear of a heat exchanger manufactured according to the operating condition; and
manufacturing the air conditioner according to a model predicted to have a lowest noise level among results obtained by repeating the processes of modeling and predicting.

10. The method according to claim 9, wherein predicting the noise level from the velocity distribution of air comprises:
obtaining a velocity spectrum after transforming the velocity distribution of air to information of a velocity of air in a frequency domain; and
predicting the noise level from values of first to third peaks of the velocity spectrum.
